(19) United States
(12) Patent Application Publication
(10) Pub. No.: US 2009/0296723 A1
(43) Pub. Date: Dec. 3, 2009

(54) Multi-computer switch with function of transmitting data between computers

(76) Inventors: Chi-Tung Chang, Taipei (TW); Chien-Han Huang, Taipei (TW); Shih-Min Lan, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/219,558

(22) Filed: Jul. 24, 2008

(30) Foreign Application Priority Data
Jun. 2, 2008 (TW) 97209624

(51) Int. Cl. H04L 12/28

(52) U.S. Cl. 370/401

(57) ABSTRACT

A multi-computer switch with a function of transmitting data between computers includes a multiple of hub units, at least one data transmission control unit and a switching interface control unit. Each hub unit includes an upstream port and a multiple of downstream ports. The upstream port is connected to a computer system, and each downstream port further includes at least one first downstream port and at least one second downstream port. The data transmission control unit is bridged to a first downstream port of any two hub units for transmitting data between computer systems connected to the two hub units according to a data exchange signal. The switching interface control unit switches and connects at least one first common peripheral to the second downstream port of one of the hub units to achieve the effect of timely transmitting data in different computers.

### BACKGROUND OF THE INVENTION

1. Field of the Invention

The present invention relates to a multi-computer switch, and more particularly to a multi-computer switch with a function of transmitting data between computers.

2. Description of Related Art

As science and technology advance rapidly, computers become increasingly popular and extensively used. If a user possesses a multi-computer system and wants to share a same set of peripherals (or control devices), the user needs to use a multi-computer switch, which is called a keyboard-video-mouse switch (KVM Switch) for controlling a switch, so that the multi-computer system no longer needs to be connected to each peripheral, so as to greatly save spaces.

With reference to FIG. 1 for a schematic diagram of an application of a conventional multi-computer switch, wherein the multi-computer switch 50 comes with a design of two ports, and one end is connected to a first computer system 61 and a second computer system 62, and another end is provided for connecting a plurality of peripherals 70 such as a keyboard, a mouse, a screen, a speaker, and microphone, etc. Therefore, users can switch the multi-computer switch 50 to use the peripherals 70 and connect to one of the computer systems.

Although present multi-computer switches can save space significantly and allow multi-computer system users to use the same set of peripherals for each computer system, but now-a-days computer users often perform operations of transmitting, exchanging, and backing up a large quantity of data as well in addition to simply switching between computers, and thus the limitations of conventional art can be inconvenient to users, and can be problematic if users use the multi-computer switch to operate computer systems and want to transmit data from a computer system to another computer system. More detailed explanation is provided below.

At present, the following conventional methods are used. One method is to use a third party's external device (such as a flash stick and a mobile hard disk) for a transfer, and users duplicate data from one computer to the third party's external device, and then switch the multi-computer switch to another computer to paste the data. Another method is to connect each computer system to a network hub in order to set up an Internet protocol on the computer system, and open a data folder for sharing functions, so as to achieve the effect of transmitting data between computers. A further method is to transmit data by a near field radio frequency (RF) transmission protocol such as Bluetooth and infrared transmission protocols, and this method requires two sets of computer systems having a module that supports the radio frequency transmission, and also requires users to confirm the settings of both parties before transmitting data.

From the description above, the structure of the conventional multi-computer switches still has drawbacks on data transmission between computer systems, in particularly users have to switch among different computer systems by the multi-computer switch from time to time for transmitting, exchanging, or backing up of data. The inconvenient operation and application of the conventional multi-computer switch require improvements.

### SUMMARY OF THE INVENTION

In order to overcome the foregoing shortcomings of the prior art, the present invention provides an improved multi-computer switch.

It is a primary objective of the present invention to enhance the hardware design of a hub and data transmission chip and to operate along with a program interface, such that users can connect several computers through a multi-computer switch, and transmit data between the computers by operating only one of the computers, so as to achieve the purpose of timely transmitting data among different computers.

To achieve the foregoing objective, the present invention provides a multi-computer switch with a function of transmitting data between computers, comprising: a plurality of hub units, at least one data transmission control unit and a switching interface control unit. Each hub unit includes an upstream port and a plurality of downstream ports, and the upstream port is connected to a computer system, and the downstream ports include at least one first downstream port and at least one second downstream port. The data transmission control unit is bridged with the first downstream port of any two hub units for transmitting data between computer systems connected to the two hub units according to a data exchange signal. The switching interface control unit is connected to at least one first common peripheral and the second downstream ports of the hub units for switching and connecting the first common peripherals to only one of the hub units.

To achieve the foregoing objective, the present invention provides a multi-computer switch with a function of transmitting data between computers, comprising: a plurality of hub units, at least one flash memory, at least one data transmission control unit, and a switching interface control unit. Each hub unit includes an upstream port and a plurality of downstream ports, and the upstream port is connected to a computer system, and the downstream ports include at least one first downstream port and at least one second downstream port. The data transmission control unit is bridged to any two first downstream ports of the hub units, and connected to the flash memory for exchanging and transmitting data between computer systems connected to the two hub units through the flash memory according to a data exchange signal. The switching interface control unit, connected to at least one first common peripheral and the second downstream ports of the hub units, is for switching and connecting the first common peripherals to only one of the hub units.

Therefore, the present invention can achieve the effect of transmitting data between computers without requiring users to switch to different computer systems from time to time when the users are using the multi-computer switch for operating different computer systems, and users can simply operate one of the computers for transmitting data between computers, and the multi-computer switch of the invention has advantages on practicability and convenience.

In addition to the general description above, preferred embodiments together with related drawings are provided for illustrating the method, the technical measure, and the performance of the present invention that achieve the expected objectives, and other objectives and advantages of the present invention will be described as follows.

### BRIEF DESCRIPTION OF THE DRAWINGS

FIG. 1 is a schematic diagram of an application of a conventional multi-computer switch;

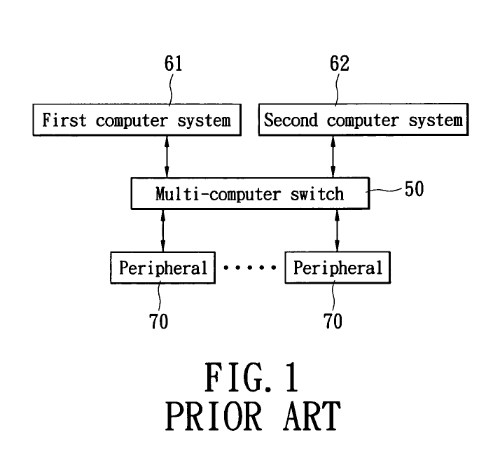

FIG. 2 is a schematic diagram of a multi-computer switch with a function of transmitting data between computers in accordance with a first preferred embodiment of the present invention;

FIG. 3 is a schematic diagram of a data transmission control unit in accordance with a first preferred embodiment of the present invention;

FIG. 4 is a schematic diagram of a multi-computer switch with a function of transmitting data between computers in accordance with a second preferred embodiment of the present invention;

FIG. 5 is a schematic diagram of a data transmission control unit in accordance with a second preferred embodiment of the present invention; and

FIG. 6 is a schematic view of an interface in accordance with a preferred embodiment of the present invention.

### DETAILED DESCRIPTION OF THE PREFERRED EMBODIMENTS

The present invention provides a multi-computer switch to achieve the purpose of transmitting data between computers by enhancing the design of the hub chip and the data transmission chip, such that a user no longer needs to switch the computer systems from time to time for transmitting data between computers while the user is using a multi-computer switch, so as to prevent interruption or influencing the current operating procedure for directly and timely completion of a data transmission.

As known, the number of ports supported by the multi-computer switch indicates the number of computer systems that can be supported by the multi-computer switch. However, the number of ports supported by the multi-computer switch of the present invention is not limited. For simplicity, two ports are adopted in the following preferred embodiments for illustrating the present invention, but these embodiments are not meant to be limiting in terms of the number of ports.

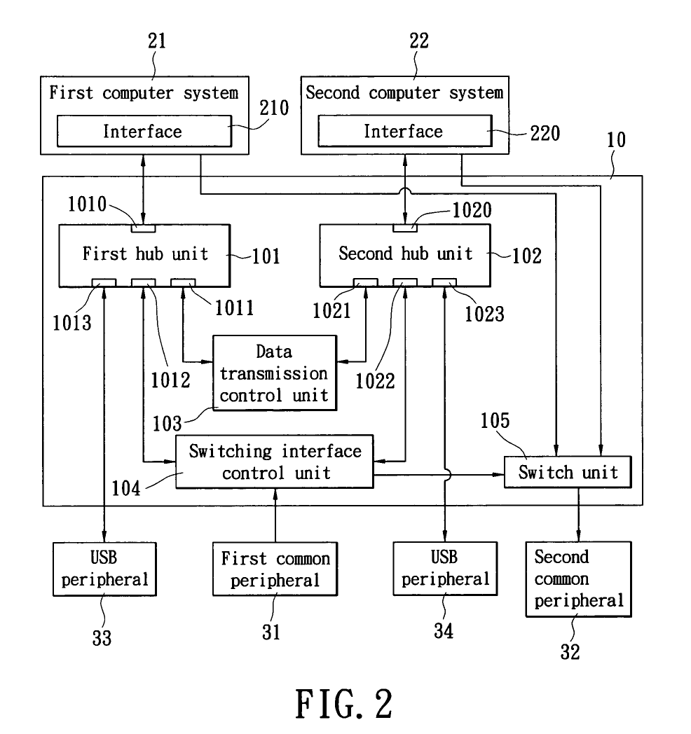

With reference to FIG. 2 for a schematic diagram of a multi-computer switch with a function of transmitting data between computers in accordance with a first preferred embodiment of the present invention, the multi-computer switch 10 comprises: a first hub unit 101, a second hub unit 102, a data transmission control unit 103, a switching interface control unit 104 and a switch unit 105. The quantity of hub units indicates the quantity of ports supported by the multi-computer switch 10 of the present invention's preferred embodiment. Since the design of the data transmission control unit 103 is adopted for transmitting data between two hub units, therefore the design of this embodiment simply requires one data transmission control unit 103 for bridging the first hub unit 101 and the second hub unit 102.

Both of the first hub unit 101 and the second hub unit 102 adopt the USB specification and respectively includes an upstream port 1010, 1020 and a plurality of downstream ports, wherein the first hub unit 101 and the second hub unit 102 are respectively connected to a first computer system 21 and a second computer system 22 through their respective upstream ports 1010, 1020. The downstream port provided by the hub unit generally refers to a port provided for connecting a downstream device. For simplicity, the downstream ports of the first hub unit 101 and the second hub unit 102 are considered as separate ports for the illustration, and include: at least one first downstream port 1011, 1021, at least one second downstream port 1012, 1022 and at least one third downstream port 1013, 1023.

The data transmission control unit 103 is bridged to the first downstream ports 1011, 1021 respectively of the first hub unit 101 and the second hub unit 102. Furthermore, the data transmission control unit 103 is provided for transmitting data between the computer system 21 connected to the first hub unit 101 and the computer system 22 connected to the second hub unit 102 according to a data exchange signal.

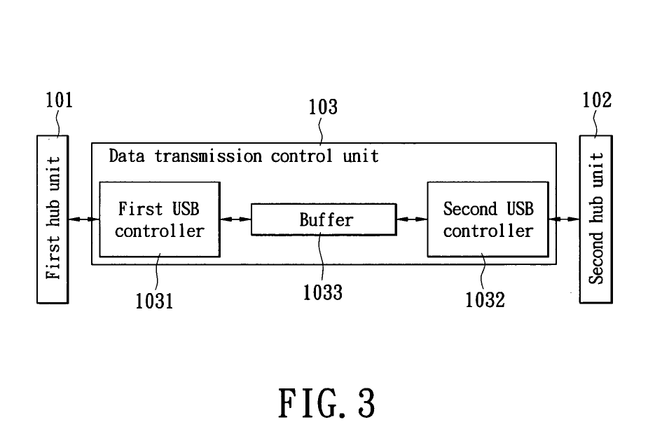

Since the data transmission control unit 103 is a downstream device relative to the first hub unit 101 and the second hub unit 102, and connected as a client of the first computer system 21 and as a client of the second computer system 22 at a host, therefore the data transmission control unit 103 adopts a user defined class established by Microsoft for its design of a host-to-host bridging and transmission through the specification of the protocol. With reference to FIG. 3 for a schematic diagram of a data transmission control unit in accordance with a first preferred embodiment of the present invention, the data transmission control unit 103 further comprises: a first USB controller 1031, a second USB controller 1032 and a buffer 1033. The first USB controller 1031 is coupled to the first hub unit 101 for confirming and connecting the first computer system 21 through the first hub unit 101, and the second USB controller 1032 is coupled to the second hub unit 102 for confirming and connecting the second computer system 22 through the second hub unit 102 for transmitting data. Finally, the buffer 1033 is coupled between the first USB controller 1031 and the second USB controller 1032 for buffering the data transmitted between the first computer system 21 and the second computer system 22. Therefore, the data transmission control unit 103 can transmit data directly according to the data exchange signal under the standard of the protocol.

The first computer system 21 and the second computer system 22 further comprise interfaces 210, 220 respectively, and any one of the interfaces 210, 220 can generate the aforementioned data exchange signal provided to the corresponding connected data transmission control unit 103. In actual operations, users simply need to operate the interface 210 of the first computer system 21 or the interface 220 of the second computer system 22 to control the data exchange and transmission between the first computer system 21 and the second computer system 22.

If the multi-computer switch 10 comes with a design of supporting two or more ports, then a user will be able to select an interface of a computer system, such that the interface can provide an option for the user to specify a currently used computer system to transmit data with one of the other computer systems. After the selection and connection are completed, the user can operate the interface to generate a data exchange signal.

An end of the switching interface control unit 104 in the multi-computer switch 10 is connected to at least one first common peripheral 31, and another end of the switching interface control unit 104 is connected to the first hub unit 101 and the second downstream port 1012, 1022 of the second hub unit 102, furthermore the first common peripheral 31 is switched to connect either the first hub unit 101 or the second hub unit 102. The first common peripheral 31 refers to an input device such as a keyboard and a mouse shared by users for switching the first computer system 21 and the second computer system 2.

Those skilled in the art should know that if the switching interface control unit 104 can support and connect three first common peripherals 31, then three second downstream ports 1012, 1022 are required for the first hub unit 101 and second hub unit 102 respectively to connect the switching interface control unit 104. In addition, users can set up hotkeys of the keyboard or design press keys (not shown in the figure) on an external casing of the multi-computer switch 10 for the operation of the switching interface control unit 104 to switch and select a computer system.

It is noteworthy to point out that the interface of the first common peripheral 31 can be a USB interface or a PS/2 interface, and the switching interface control unit 104 can be designed with a converter (not shown in the figure) for converting the signal specification from the PS/2 interface into the USB interface, but the present invention is not limited to such arrangement only.

Furthermore, an end of the switch unit 105 in the multi-computer switch 10 is connected to at least one second common peripheral 32, and the other end of the switch unit 105 is connected directly to the first computer system 21 and the second computer system 22 for receiving the switch control of the switching interface control unit 104, while switching the connection of the second common peripheral 32 to the first computer system 21 or the second computer system 22. The second common peripheral 32 can be an output device such as a monitor screen, a speaker, and a microphone provided for users to share and switch the operation at the first computer system 21 and the second computer system 22. Since the switch unit 105 receives the control from the switching interface control unit 104 for a corresponding switch, and the switching interface control unit 104 is switched to the first hub unit 101 for connecting the first computer system 21, thereby the switch unit 105 is connected to the first computer system 21 for the corresponding switch.

Finally, it is noteworthy to point out that the third downstream ports 1013, 1023 respectively provided by the first hub unit 101 and the second hub unit 102 in this embodiment are USB ports respectively provided for users to connect USB peripherals 33, 34 (such as a printer and a flash disk). If the first hub unit 101 and the second hub unit 102 provide sufficient third downstream ports 1013, 1023, users will be able to connect more external USB peripherals 33, 34.

Since the third downstream ports 1013, 1023 have not gone through the switch control of the switching interface control unit 104, but they are provided externally by the first hub unit 101 and the second hub unit 102, therefore the third downstream ports 1013, 1023 are respectively used as extension ports of the first computer system 21 and the second computer system 22, and the connected USB peripherals 33, 34 are respectively operated with the first computer system 21 and the second computer system 22 independently.

In view of the description above, the present invention provides a multi-computer switch 10 capable of transmitting data between computers.

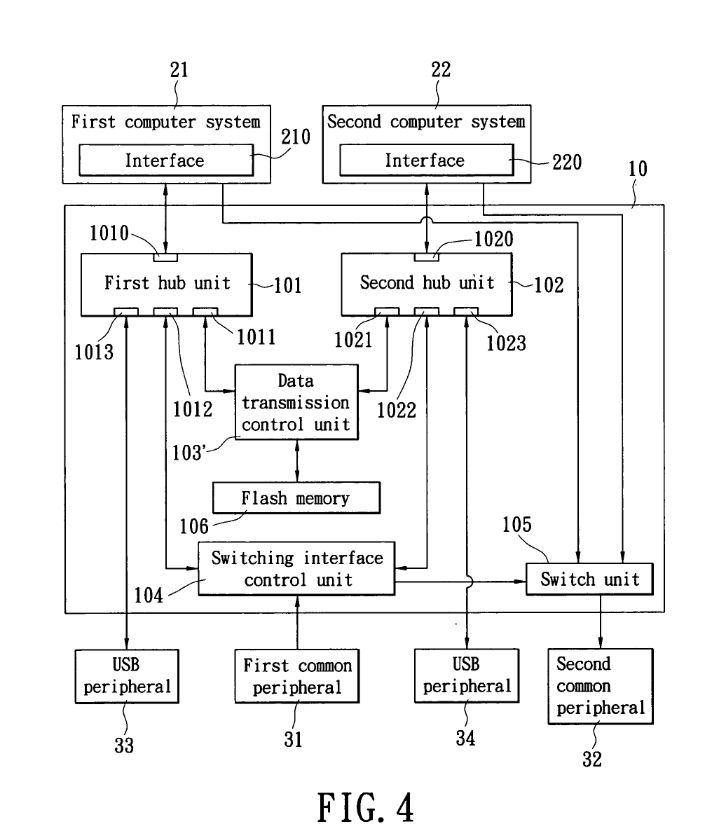

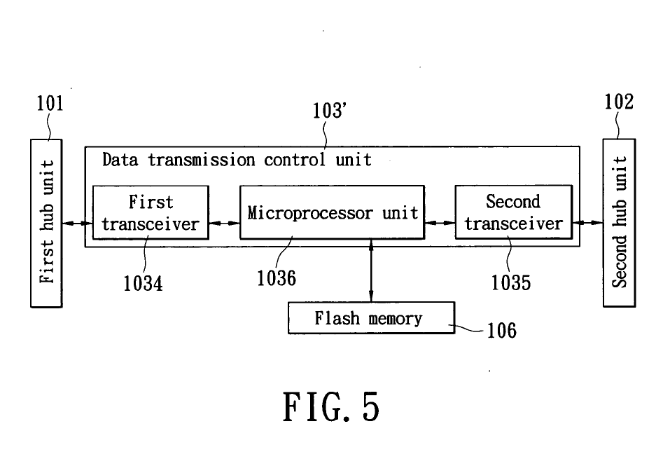

With reference to FIGS. 4 and 5 respectively representing schematic diagrams of a multi-computer switch and a data transmission control unit with a function of transmitting data between computers in accordance with a second preferred embodiment of the present invention, wherein the multi-computer switch 10 as shown in FIG. 4 has a structure substantially the same as that of the first preferred embodiment, and the major difference resides on that the multi-computer switch 10 of the second preferred embodiment adds a flash memory 106, and the data transmission control unit 103′ has a different design, so that data can be transmitted between the first computer system 21 and the second computer system 22 without using the specification of the protocol, but can simply use the flash memory 106 for buffering and exchanging the data to complete the data transmission.

The data transmission control unit 103′ is bridged to the first downstream ports 1011, 1021 respectively of the first hub unit 101 and the second hub unit 102, and connected to the flash memory 106, so that when the data exchange signal is generated, the data transmitted and exchanged between the first hub unit 101 and the second hub unit 102 is buffered into the flash memory 106.

In FIG. 5, the data transmission control unit 103′ of the second preferred embodiment further comprises a first transceiver 1034, a second transceiver 1035 and a microprocessor unit 1036. Of course, those skilled in the art know that a transceiver with a USB 2.0 Transceiver Microcell Interface (UTMI) is provided for processing the USB protocol and signals such as the data serialization, data deserialization, bit stuffing, clock recovery, and synchronization specified by the USB interface specification

In the second preferred embodiment, it is necessary to design a first transceiver 1034 and a second transceiver 1035 respectively corresponding to the connected first computer system 21 and second computer system 22. The first transceiver 1034 is connected to the first hub unit 101 for confirming and connecting the first computer system 21 through the first hub unit 101. The second transceiver 1035 is connected to the second hub unit 102 for confirming and connecting the second computer system 22 through the second hub unit 102. The microprocessor unit 1036 is provided for controlling the operation of the first transceiver 1034 and the second transceiver 1035, and the flash memory 106 is provided for buffering and exchanging data to complete the data transmission between the first computer system 21 and the second computer system 22.

With the design of the second preferred embodiment, the present invention also provides a multi-computer switch 10 capable of transmitting data between computers in a timely fashion.

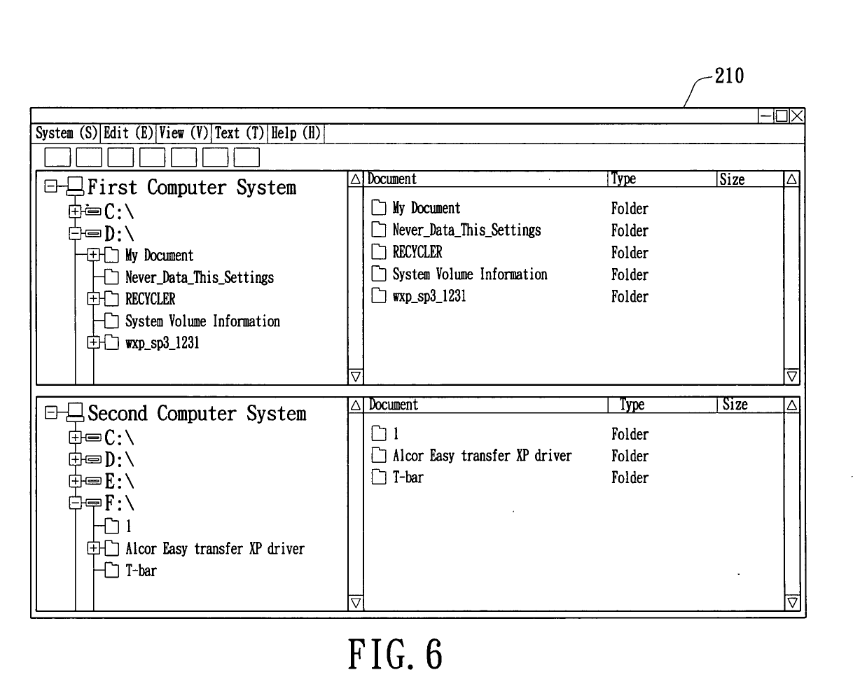

With reference to FIG. 6 for a schematic view of an interface in accordance with a preferred embodiment of the present invention, the interface 210 is an interface of the first computer system 21 operated by users. In FIG. 6, after the first computer system 21 and the second computer system 22 are connected through the data transmission control unit 103, 103′ of the multi-computer switch 10, the upper half of the interface 210 displays a file management screen of the first computer system 21 operated by the users, and the lower half of the interface 210 displays a file management screen of another other computer system (such as the second computer system 22) connected to the multi-computer switch 10.

If a user drags, duplicates, pastes, or deletes a file between the upper and lower halves of the interface 210, the interface 20 will generate a data exchange signal for achieving the file exchange and transmission between the first computer system 21 and the second computer system 22.

In summation of the description above, the present invention adds a hardware design of a hub unit and a data transmission control unit to a multi-computer switch and adopts a program interface, so that when a user connects a multi-computer system by the multi-computer switch, the user no longer needs to switch to different computer systems from time to time, but simply only needs to operate at one of the computer systems for transmitting data between different computer systems. Obviously, the multi-computer switch of the present invention complies with the patent application requirements, and thus is duly filed for patent application.

Although the present invention has been described with reference to the preferred embodiments thereof, it should be understood that the present invention is not limited to the details thereof. Various substitutions and modifications have been suggested in the foregoing description, and others will occur to those of ordinary skill in the art. Therefore, all such substitutions and modifications are intended to be embraced within the scope of the present invention as defined in the appended claims.

What is claimed is:

1. A multi-computer switch with a function of transmitting data between computer systems, comprising:
a plurality of hub units, each including an upstream port and a plurality of downstream ports, and the upstream port being coupled to a computer system, and the downstream ports including at least one first downstream port and at least one second downstream port;
at least one data transmission control unit, bridged with any two first downstream ports of the hub units, for transmitting data between computer systems connected to the two hub units according to a data exchange signal; and
a switching interface control unit, coupled to at least one first common peripheral and the second downstream ports of the hub units, for switching and connecting the first common peripherals to only one of the hub units.

2. The multi-computer switch with a function of transmitting data between computers of claim 1, wherein the computer systems comprise an interface for generating the data exchange signal to a corresponding bridged data transmission control unit.

3. The multi-computer switch with a function of transmitting data between computers of claim 2, wherein the hub units are USB hub units.

4. The multi-computer switch with a function of transmitting data between computers of claim 3, wherein the data transmission control unit further comprises:
a first USB controller, bridged with one of the two hub units, and coupled to a first computer system through the bridged hub unit for transmitting data;
a second USB controller, bridged with another one of the two hub units, and
coupled to a second computer system through the bridged hub unit for transmitting data; and
a buffer, coupled to the first USB controller and the second USB controller, for buffering and transmitting data between the first computer system and the second computer system.

5. The multi-computer switch with a function of transmitting data between computers of claim 3, wherein the downstream ports further comprise at least one third downstream port for externally connecting at least one USB peripheral.

6. The multi-computer switch with a function of transmitting data between computers of claim 2, further comprising:
a switch unit, coupled to at least one second common peripheral and the computer systems, for receiving a switch control of the switching interface control unit to connect the second common peripherals to only one of the computer systems.

7. A multi-computer switch with a function of transmitting data between computer systems, comprising:
a plurality of hub units, including an upstream port and a plurality of downstream ports, the upstream port being coupled to a computer system, and the downstream ports including at least one first downstream port and at least one second downstream port;
at least one flash memory;
at least one data transmission control unit, bridged to any two first downstream ports of the hub units, and coupled to the flash memory for exchanging and transmitting data between the computer systems that is coupled to the two hub units through the flash memory according to a data exchange signal; and
a switching interface control unit, coupled to at least one first common peripheral and the second downstream ports of the hub units, for switching and connecting the first common peripherals to only one of the hub units.

8. The multi-computer switch with a function of transmitting data between computers of claim 7, wherein the computer system comprises an interface for generating the data exchange signal to a corresponding bridged data transmission control unit.

9. The multi-computer switch with a function of transmitting data between computers of claim 8, wherein the hub units are USB hub units.

10. The multi-computer switch with a function of transmitting data between computers of claim 9, wherein the data transmission control unit further comprises:
a first transceiver, bridged with one of the two hub units, and coupled to a first computer system through the bridged hub unit;
a second transceiver, bridged with another one of the two hub units, and
coupled to a second computer system through the bridged hub unit; and
a microprocessor unit, for controlling operations of the first transceiver and the second transceiver, and transmitting data between the first computer system and the second computer system through a data exchange and buffer of the flash memory.

11. The multi-computer switch with a function of transmitting data between computers of claim 9, wherein the downstream ports further comprise at least one third downstream port for externally connecting at least one USB peripheral.

12. The multi-computer switch with a function of transmitting data between computers of claim 8, further comprising:
a switch unit, coupled to at least one second common peripheral and the computer systems, for receiving a switch control of the switching interface control unit to connect the second common peripherals to only one of the computer systems.
